(19) United States
(12) Patent Application Publication
(10) Pub. No.: US 2025/0028999 A1
(43) Pub. Date: Jan. 23, 2025

(54) SYSTEM AND METHOD FOR AUTOMATICALLY IMPROVING CLASSIFICATION MODELS FOR MULTI-ATTRIBUTE CLASSIFICATION

(71) Applicant: Shopify Inc., Ottawa (CA)

(72) Inventors: SHAKED DUNAY, Rehovot (IL); ADAM MALLOUL, Rishon LeTsiyon (IL); RONI GURVICH, Ramat Gan (IL); SHIVAM KUMAR, Reading Berkshire (GB)

(21) Appl. No.: 18/355,247

(22) Filed: Jul. 19, 2023

(51) Int. Cl. G06N 20/00

(52) U.S. Cl. CPC G06N 20/00

(57) ABSTRACT

A computer-implemented method and system for optimally and automatically improving a multi-attribute classification model in response to a performance criteria. The computer implemented method comprises providing a multi-attribute classifier trained to classify a plurality of attributes; evaluating a performance of the multi-attribute classifier for classifying each attribute of the plurality of attributes; determining that the performance of the multi-attribute classifier for at least a particular attribute of the plurality of attributes falls below a defined standard; responsive to determining that the performance of the multi-attribute classifier for at least the particular attribute of the plurality of attributes falls below the defined standard, causing training and generating of a single attribute classifier for classifying the particular attribute, wherein the single attribute classifier is subsequently used in combination with the multi-attribute classifier for classifying the particular attribute of the plurality of attributes.

### FIELD

The present application relates to computerized systems and methods for automatically improving classification models for multi-attribute classification, and particularly to automatically training and constructing multi-attribute classification models in response to performance criteria.

### BACKGROUND

Multi-attribute classification models (also referred to as multi-output classification models or multi-class multi-output classification models) are a form of machine learning model. Multi-attribute classification models are distinguished from binary classification models which only offer a single prediction score as to the system's certainty that a given observation or input belongs to a particular or positive class or label associated with that model in that one multi-attribute classification model provides predictions (on a per category basis, i.e., as different outputs) as to the multi-attribute classification model's certainty that a given observation or input belongs to each of a set of categories associated with that model. As such, unlike a binary classification model which will only have a single output, a multi-attribute classification model will have n outputs, where n is the number of classes associated with that model.

### SUMMARY

In computerized machine learning classification systems, accurately predicting multiple attribute values for different attribute types or features in real-time is a computationally challenging and error prone process. Generally, multi-output classification models apply machine learning techniques to provide two or more predictive outputs, where each of the outputs may provide an attribute value for a particular attribute or feature. For such models, it is particularly difficult for the computerized classification model to optimize both accuracy of prediction for each of the attributes provided via multiple outputs while optimizing the number of output classifications provided by the model. For example, the performance of such classification models may be inadequate such as a decay over time related to data drift, or the model may fail to perform classification accurately for some attributes since the multi-output classification model is optimized for classifying multiple features or attributes simultaneously.

In some cases, multi-attribute classification models may perform visual attribute classification to enable highly relevant search results by tagging attributes of an object within a digital image, such as for an e-commerce product. For example, for an e-commerce product depicting shoes, the attributes may be “shoe-type”, “heel-type”, “color”, “pattern”, and “style”. A single multi-attribute classification model may be trained to classify multiple attributes of a digital image such as for an e-commerce product i.e. shoe-type, color, pattern, style and heel type. Over time, data drift may occur when there is a significant gap between the data the model was trained on and the data the model faces when used in production. Thus, the model may become less accurate over time. In some circumstances, the model may lose accuracy in its classification of a single attribute but still have high accuracy when classifying other attributes. It may not be possible to improve the accuracy of the current model for classifying the particular attribute without retraining it from scratch. The resulting model may be good at classifying the previous problematic attribute but performance on one or more of the other attribute classification tasks may be negatively affected thereby presenting new concerns.

Additionally, it is not feasible nor computationally efficient to train a separate model for each different attribute or sub-type of an attribute being classified, particularly as the number of attributes or features being classified increases. Training a separate model for each of the set of attributes, is extremely computationally expensive and resource intensive to train and use for inference, therefore unfeasible as the number of attributes grows.

As an example scenario, ten different classification models predicting ten individual attributes (e.g. training a single classifier per class) may each result in an image or other input data being parsed by a hundred models and thus computationally very expensive to implement. Additionally, such models may only consider a single attribute at a time without considering a holistic approach of relationships between the attributes. A combined multi-classification model is only slightly bigger in terms of storage size and takes slightly more time for prediction and not on a linear scale. As a result having a combined multi-classification model has better quality of results, less resource consumption and less time to process the input data overall.

However, there is a need to improve underperforming multi-attribute classifiers to address at least some of the deficiencies described, such as for improved accuracy and coverage of all of the attributes while reducing strain on computational resources, such as for effective and live classification of multiple attributes and associated attribute values in real-time environments.

Computational approaches are described herein in various embodiments whereby computer systems and methods are configured to automatically and intelligently update construction of a multi-attribute classifier (e.g. multi-class multi-output classifier also known as a multitask classifier) to predict multiple attribute values with high precision while maximizing the prediction coverage or recall.

A system of one or more computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, may cause the apparatus to perform the actions.

One general aspect includes a computer implemented method comprising: providing a multi-attribute classifier trained to classify a plurality of attributes; evaluating a performance of the multi-attribute classifier for classifying each attribute of the plurality of attributes; determining that the performance of the multi-attribute classifier for at least a particular attribute of the plurality of attributes falls below a defined standard; responsive to determining that the performance of the multi-attribute classifier for at least the particular attribute of the plurality of attributes falls below the defined standard, causing training and generating of a single attribute classifier for classifying the particular attribute, wherein the single attribute classifier is subsequently used in combination with the multi-attribute classifier for classifying the particular attribute of the plurality of attributes.

Other embodiments of this aspect may include corresponding computer systems, apparatus, and computer programs recorded on one or more computer storage devices, each configured to perform the actions of the methods.

In one aspect, the defined standard may be a threshold associated with training criteria for the multi-attribute classifier and evaluating the performance includes: applying the multi-attribute classifier to a test data set to determine a performance score for each said attribute; and comparing the performance score for at least the particular attribute to the threshold for the multi-attribute classifier in classifying attributes.

In yet another aspect, the single attribute classifier is caused to be trained with a new data set different from an original training data set for the multi-attribute classifier.

In yet another aspect, the new data set may be biased towards containing only samples related to the particular attribute.

In yet another aspect, the new data set may be a subset of a larger data set, and the original training data set was generated by filtering that larger data set based on a criterion.

In yet another aspect, the new data set may be generated by filtering the original training data set for samples having only the particular attribute.

In yet another aspect, the method may further comprise: determining that the particular attribute may be related to a particular category of object and causing the new data set to contain samples related to the particular attribute for categories of available objects other than the particular category of object in addition to samples related to the particular category of object.

In yet another aspect, the defined standard is a precision constraint value.

In yet another aspect, the defined standard may include: a precision constraint value and a recall value; and wherein determining that the performance for the particular attribute falls below the defined standard includes: determining that: the performance for the particular attribute meets the precision constraint value; and responsive to determining that the performance for the particular attribute meets the precision constraint value, generating the single attribute classifier for the particular attribute.

In yet another aspect, the method further comprising: providing a system comprising the multi-attribute classifier and the single attribute classifier; and in response to the particular attribute having the performance below the defined standard for the multi-attribute classifier, the system configured for applying the single attribute classifier instead of the multi-attribute classifier for classifying the particular attribute.

In yet another aspect, training of the single attribute classifier additionally may comprise evaluating performance for the single attribute classifier to determine whether meets the defined standard and responsive to evaluating that the performance fails to meet the defined standard causing re-training of the single attribute classifier.

In yet another aspect, the method may further comprise tracking performance of the multi-attribute classifier together with one or more single attribute classifiers to determine whether to generate additional single attribute classifiers based on the tracking, wherein each single attribute classifier is used for classifying a respective associated attribute instead of the multi-attribute classifier.

In yet another aspect, the multi-attribute classifier may be a multi-class multi-output classifier wherein each said attribute of the plurality of attributes input to the multi-attribute classifier may be associated with a separate classification output.

Implementations of the described techniques may include hardware, a method or process, or computer software on a computer-accessible medium.

In yet another aspect, there may be provided a computer system comprising: at least one processor; and a storage storing instructions that, when executed by at least one of the at least one of the processor, cause the system to: provide a multi-attribute classifier trained to classify a plurality of attributes; evaluate a performance of the multi-attribute classifier for classifying each attribute of the plurality of attributes; determine that the performance of the multi-attribute classifier for at least a particular attribute of the plurality of attributes falls below a defined standard; responsive to determining that the performance of the multi-attribute classifier for at least the particular attribute of the plurality of attributes falls below the defined standard, cause training and generating of a single attribute classifier for classifying the particular attribute, wherein the single attribute classifier is subsequently used in combination with the multi-attribute classifier for classifying the particular attribute of the plurality of attributes.

Other embodiments of this aspect may include corresponding computer systems, apparatus, and computer programs recorded on one or more computer storage devices, each configured to perform the actions of the methods.

In yet another aspect, there may be provided a computer readable medium having instructions tangibly stored thereon, wherein the instructions, when executed by at least one processor of a computer system cause the computer system to: provide a multi-attribute classifier trained to classify a plurality of attributes; evaluate a performance of the multi-attribute classifier for classifying each attribute of the plurality of attributes; determine that the performance of the multi-attribute classifier for at least a particular attribute of the plurality of attributes falls below a defined standard; responsive to determining that the performance of the multi-attribute classifier for at least the particular attribute of the plurality of attributes falls below the defined standard, cause training and generating of a single attribute classifier for classifying the particular attribute, wherein the single attribute classifier may be subsequently used in combination with the multi-attribute classifier for classifying the particular attribute of the plurality of attributes.

Other embodiments of this aspect may include corresponding computer systems, apparatus, and computer programs recorded on one or more computer storage devices, each configured to perform the actions of the methods.

There may also be provided a computer program product comprising a non-transient storage device storing instructions that when executed by at least one processor of a computing device, configure the computing device to perform operations in accordance with the methods discussed herein.

These and other aspects will be apparent to those of ordinary skill in the art.

### BRIEF DESCRIPTION OF THE DRAWINGS

Embodiments will be described, by way of example only, with reference to the accompanying figures wherein:

FIG. 1 is a block diagram of an e-commerce platform in accordance with one embodiment.

FIG. 2 is an example of a home page of an administrator, according to one embodiment.

FIG. 3 illustrates the e-commerce platform of FIG. 1 but includes an engine for intelligently generating an improved classifier for multi-attribute classification based on an indication of an underperforming existing multi-attribute classifier, according to one embodiment.

FIG. 4 is a further detailed example of the computing components and modules of the engine of FIG. 3, according to one embodiment.

FIGS. 5A-5C are schematic diagrams illustrating example processes for classification model training, testing, generation and use of the model as executed by the engine of FIGS. 3 and 4 for performing optimal multi-attribute classification, according to one embodiment.

FIG. 6 is a flowchart of a computerized method, which may be implemented by the engine of FIGS. 3 and 4, for dynamically constructing an updated classification model including an existing multi-attribute model and a single attribute model generated specifically to correct performance deficiencies of the existing model, according to one embodiment.

### DETAILED DESCRIPTION

One or more currently preferred embodiments have been described by way of example. It will be apparent to persons skilled in the art that a number of variations and modifications can be made without departing from the scope of the disclosure as defined in the claims.

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

The present application relates, in at least some embodiments to a system and method of constructing classification models to improve underperforming multi-attribute classifiers. In at least some aspects, in response to detecting that the performance of a multi-attribute classifier (also referred to herein as a multi-class multi-output classification model) for classifying a particular attribute in a set of attributes of an input data set such as a product image has fallen below a desired performance criteria (e.g. threshold), the computerized systems and methods trigger training of a new single attribute classifier model for that particular attribute. In at least some aspects, the new single attribute classifier, once generated by the computerized systems and methods is combined with the multi-attribute classification model to cooperate to classify the set of attributes of the input dataset, e.g. images of an e-commerce product. Conveniently, in this manner, the proposed computerized systems thereby predict multiple attribute values for different attributes with high precision while maximizing the prediction coverage or recall of the number of attributes being classified. Additionally, by optimizing the multi-attribute classifier in this manner, the disclosed systems and methods allow optimization of computer resources and increased accuracy of performance which is not obtained in the case of multiple single attribute classifiers which learn classification for each attribute independently without considering intrinsic relationships among the attributes being classified.

Although multi-attribute classifiers can present advantages, in some cases, a multi-attribute classifier may start to decay in performance over time for one or more attributes, which may be caused by data drift where there is an evolution in the data being analyzed for prediction and there is thus a variation in production data as compared to the training data used to initially train the model.

Thus one of the goals of the disclosed systems and method, in at least some aspects, is to leverage benefits of the multi-attribute classifier which uses joint feature or attribute learning to consider relatedness among attributes while improving underperforming characteristics of an existing multi-attribute classifier for a particular attribute being classified by training and combining the multi-attribute model with a single attribute classifier model trained specifically to improve classification performance for the particular attribute.

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

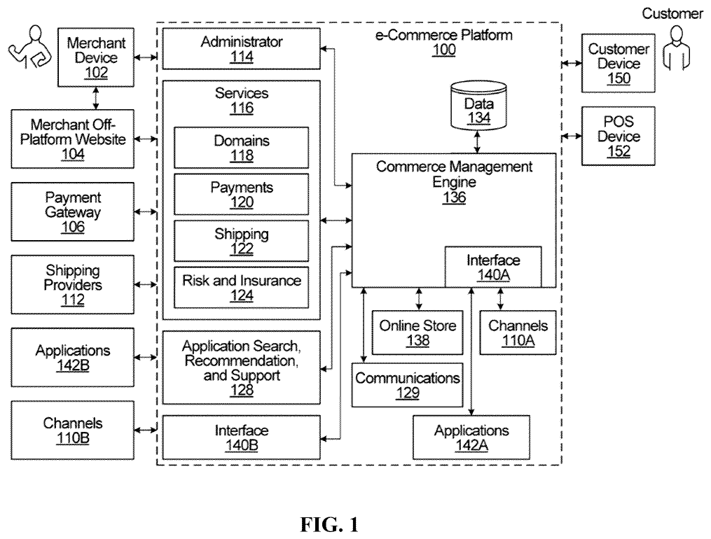

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (laaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript™, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings that may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

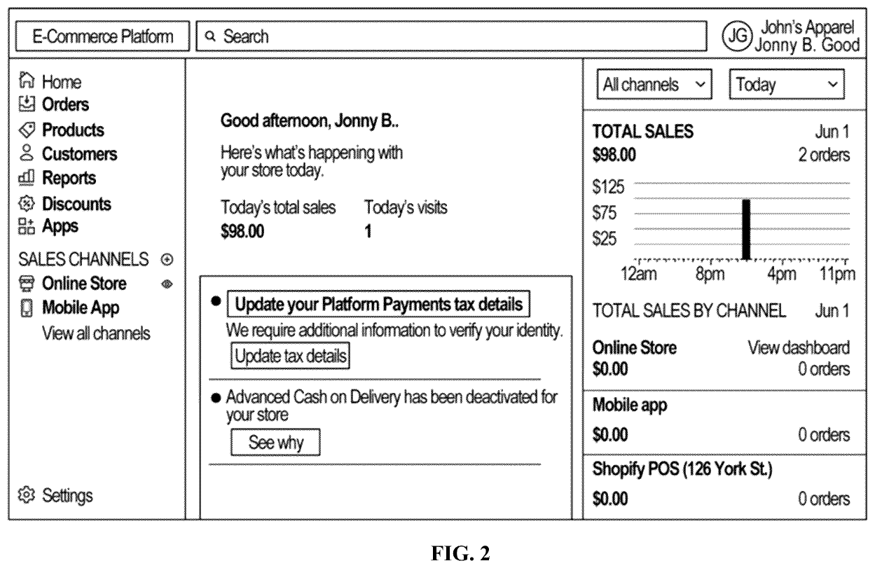

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Engine 300—Attribute Classification System

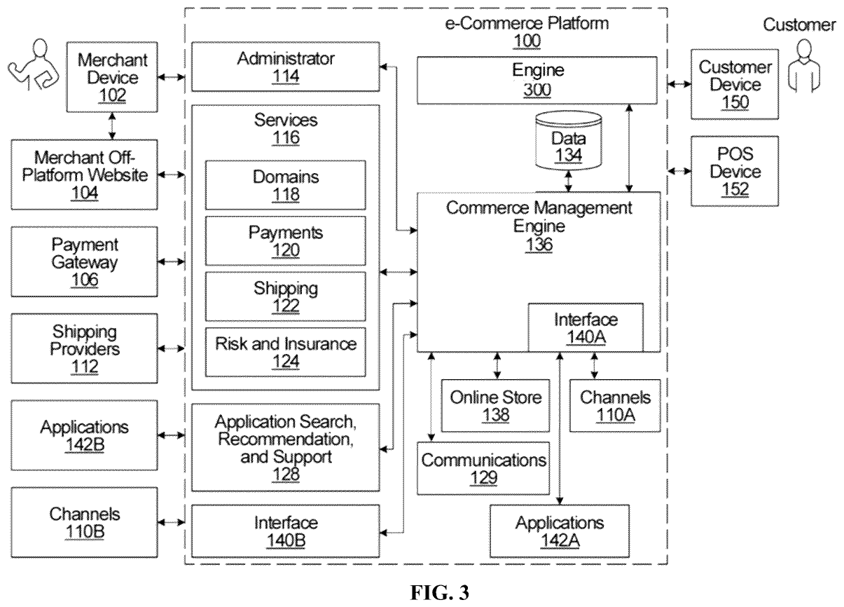

The functionality described herein may be used in e-commerce systems to provide improved online customer or buyer experiences. The e-commerce platform 100 could implement the functionality for any of a variety of different applications, examples of which are described elsewhere herein. FIG. 3 illustrates the e-commerce platform 100 of FIG. 1 but including an engine 300. The engine 300 is an example of a computer-implemented multi-attribute classification system and engine that implements the functionality described herein for performing multi-class multi-output classification and improving performance of an existing underperforming multi attribute classifier for use by the e-commerce platform 100, the customer device 150 and/or the merchant device 102.

Although the engine 300 is illustrated as a distinct component of the e-commerce platform 100 in FIG. 3, this is only an example. The engine 300 may also be provided by another component residing within or external to the e-commerce platform 100. In some embodiments, either or both of the applications 142A-B provide an engine that implements the functionality described herein to make it available to customers and/or to merchants. Furthermore, in some embodiments, the commerce management engine 136 provides the aforementioned engine. However, the location of the engine 300 is implementation specific. In some implementations, the engine 300 is provided at least in part by an e-commerce platform (e.g. e-commerce platform 100), either as a core function of the e-commerce platform or as an application or service supported by or communicating with the e-commerce platform. Alternatively, the engine 300 may be implemented as a stand-alone service to clients such as a customer device 150 or a merchant device 102. In addition, at least a portion of such an engine could be implemented in the merchant device 102 and/or in the customer device 150. For example, the customer device 150 could store and run an engine locally as a software application.

As discussed in further detail below, the engine 300 could implement at least some of the functionality described herein. Although the embodiments described below may be implemented in association with an e-commerce platform, such as (but not limited to) the e-commerce platform 100, the embodiments described below are not limited to e-commerce platforms and may be implemented in other computing devices.

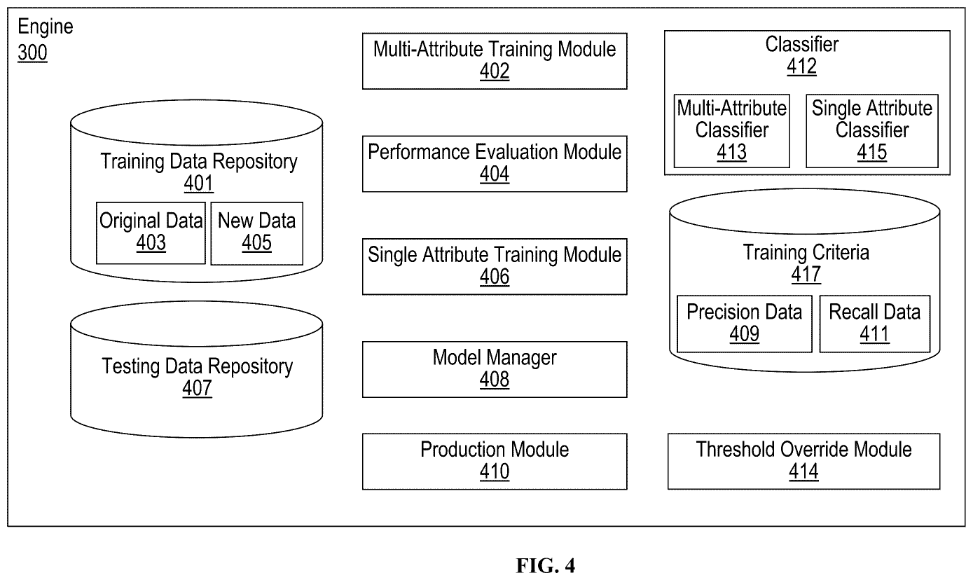

Referring to FIG. 4, shown is an example classification engine 300 according to one embodiment, which includes various computing modules and electronic data stores. As will be understood, although single instances of certain computing modules has been shown in FIG. 4 for simplicity of illustration, additional instances may be envisaged as described herein, including for example additional classifiers, repositories, training modules, evaluation modules, managers. Also, additional computing components, as may be understood by a person skilled in the art, including user interfaces, communication systems, operating systems and processors not shown in FIG. 4 to allow the communication between the modules of FIG. 4 and the implementations of the operations described herein may be envisaged and not shown for simplicity of illustration.

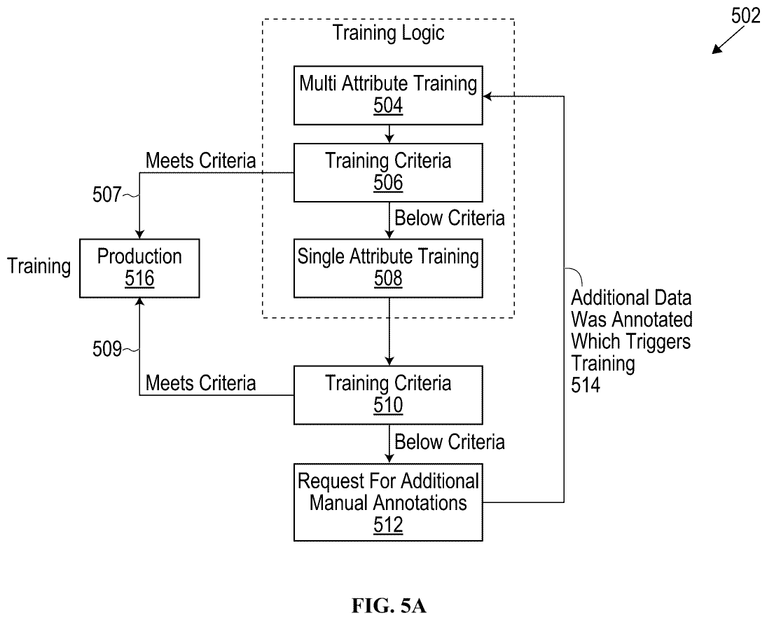

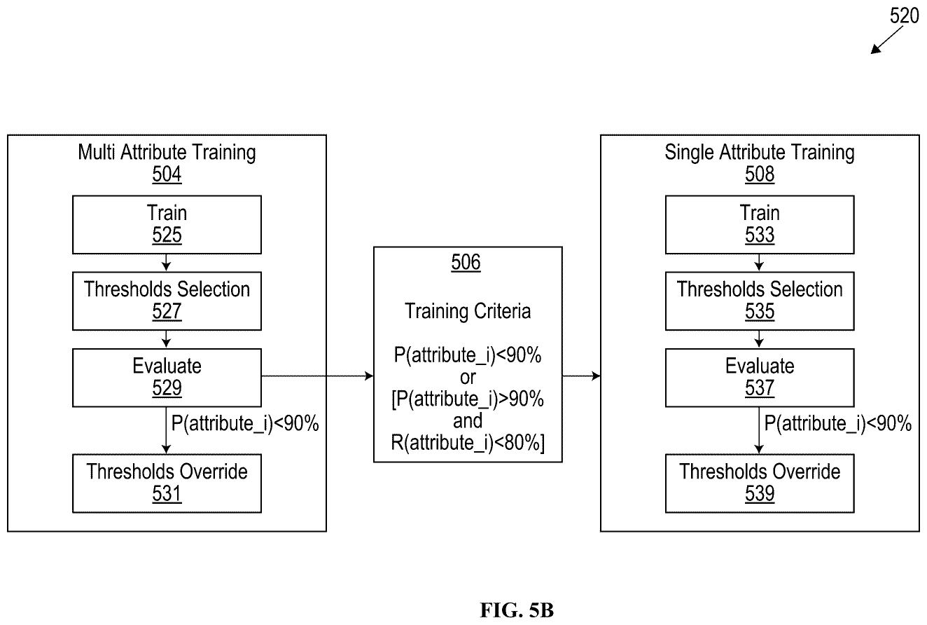

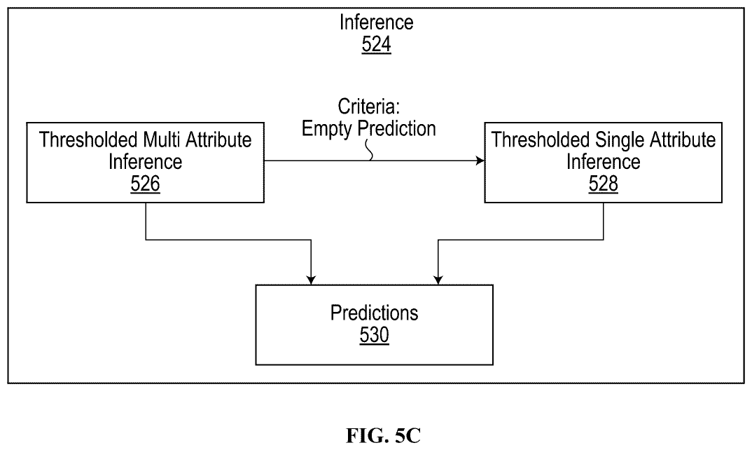

Generally, the engine 300, as illustrated in the schematic of FIG. 4 and in the example operations of FIGS. 5A-5C, is configured for training and generating single attribute classifiers specifically trained for particular attribute classification from an input dataset to cooperate with existing multi-attribute classifiers, which are underperforming for classifying the particular attributes. The engine 300 is further configured to optimize generation of the single attribute classifier to improve the performance of an existing multi attribute classifier, such as to work together to perform optimal multi-attribute classification and predict attribute values with high precision while maximizing the prediction coverage (recall). Conveniently, in this manner, the engine 300 improves the computational performance of multi-attribute classification models while automatically generating and training single attribute classifiers to address deficiencies in existing multi-attribute classifiers (e.g. as initially generated via the multi-attribute training module 402).

Referring to the engine 300 illustrated in FIGS. 3 and 4, the computing modules and data stores of the engine 300 may comprise: a training data repository 401 including original data 403, new data 405, a repository of training criteria 417 including precision data 409 and recall data 411, a testing data repository 407, a multi-attribute training module 402, a performance evaluation module 404, a single attribute training module 406, a model manager 408, a production module 410, a classifier 412, and a threshold override module 414.

The operations of the engine 300 may be automatically initiated or triggered via a requestor device (not shown) communicating with the e-commerce platform 100, such as to request evaluation of the performance of an existing multi-attribute classifier (e.g. as generated via the multi-attribute training module 402) and/or the engine 300 across one or more communications networks to perform the operations described herein.

Each of the computing components of the engine 300 including the multi-attribute training module 402, the performance evaluation module 404, the single attribute training module 406, the model manager 408, the production module 410, the classifier 412, and the threshold override module 414 may be implemented in hardware and/or software and may include instructions, logic rules, machine learning, artificial intelligence or combinations thereof stored on a memory (e.g. stored within data 134 on the e-commerce platform 100 or an external memory accessible by the engine 300) and executed by one or more processors which, as noted above, may be part of or external to the e-commerce platform 100 to provide the functionality described herein.

The engine 300 may include additional computing modules or data stores in various embodiments to provide the implementations described herein. Additional computing modules and data stores may not have been shown in FIG. 4 to avoid undue complexity of the description. For example, one or more user computing devices may detect and/or provide (e.g. via a pull or push mechanism), one or more existing multi-attribute classifiers 413, portions of the new training data in the new data 405, or testing data for the testing data repository 407, etc. For simplicity of illustration, the network through which such devices (and corresponding data servers and/or computing models) may communicate with the engine 300 is not shown in FIG. 4.

A multi-attribute training module 402 may train using training data in the training data repository 401, and generate a trained classifier 412 via the production module shown as a multi-attribute classifier 413. The multi-attribute classifier 413 is a type of machine learning model used to classify image objects or text or combinations thereof based on multiple attributes or features. Each attribute may have multiple possible values and the multi-attribute classifier 413, once trained, may assign each input data object to one or more classes and generate attribute values for each of the classes or attributes. Thus, the multi-attribute classifier 413 performs multi-class multi-output classification to predict multiple output values for each object, whereby each output value corresponds to a particular attribute or feature.

The training data repository 401 comprises an original data 403 set and a new data 405 set. As will be described, the original data 403 may refer to training data initially used by the multi-attribute training module 402 to generate.

Each of the training data may include data components, such as images, text and/or combination thereof, including one or more product identifiers (ID), visual attributes or classes of image segments or objects (e.g. color, size, shape, object type such as garment type, e-commerce product type, . . . ) and other associated features, including a text hash or an image hash within each respective data set.

For example, if the problem for the multi-attribute classifier 413 generated by the multi-attribute training module 402 is to classify images of clothing items, then the visual attributes in the training data repository 401 and/or the testing data repository may include clothing-type, garment-type, color, pattern, and style.

The multi-attribute training module 402 trains the multi-attribute classifier on a set of labeled examples to predict multiple classification outputs simultaneously, where each example training data sample (e.g. original data 403) consists of a set of input features or attributes and a set of output class labels including associated values. During training by the multi-attribute training module 402, the algorithm learns a mapping from input features to output class labels or attributes and associated values, allowing it to make predictions for new, unseen instances. In other words, each output of a trained multi-attribute classifier 413 has a fixed set of available classes (e.g. corresponding to possible attribute values) and each sample is labeled with a class for each output.

The multi-class multi-output attribute classifiers 413 may use a neural network with multiple output layers, where each output layer corresponds to a different attribute class. During training via the multi-attribute training module 402, via the training data in the training data repository 401, the neural network is optimized to simultaneously predict all of the output attributes, while minimizing the overall error across all attributes.

Overall, as described earlier, once trained, the multi-attribute classifier 413 may be a powerful computing tool for solving complex prediction problems with multiple output attributes that takes into account all the attributes at once, allowing for more accurate and consistent classifications. For example, a classifier 413 trained, using original data 403, on input samples with all three attributes (color, size, and product type) would be able to classify an input digital image of a small, red shoe more accurately than a single attribute classifier that only considers a single attribute, e.g. color. However, such models require careful monitoring of performance accuracy/recall to ensure that performance degradation hasn't occurred during the model's lifecycle.

Thus, once the multi-attribute classifier 413 is trained and generated via the production module 410, then the performance evaluation module 404 may be configured to assess performance of the multi-attribute classifier 413 using training criteria 417, which includes but not limited to: precision data 409 and recall data 411.

Generally, in order to assess the performance of an existing multi-attribute classifier 413 and trigger the operations described herein of generating a single attribute classifier to be coupled with the multi-attribute classifier, performance metrics may be evaluated by the performance evaluation module 404. The performance evaluation module 404 may access performance criteria within training criteria 417 which may include but not limited to: precision data 409, recall data 411, F1 score (a single metric comprised of the harmonic mean of precision and recall values), and a confusion matrix also known as an error matrix which visualizes the performance of the classification algorithm in terms of a predicted class versus a true class, or other performance measures as will be understood by a person skilled in the art.

Assessing the performance of an existing multi-attribute classifier 413, such as to evaluate the model's performance against a test data set (e.g. testing data repository 407) may occur in response to a defined trigger, as may be received via the model manager 408. In various aspects, such evaluation may be triggered manually, may be triggered periodically as per a schedule stored within one or more data stores of the engine 300, may be in response to detected data drifts or high threshold rejections of model predictions in real time online inference tasks. In one example, the performance evaluation module 404 performs cross validation to assess the performance of the multi-attribute model on unseen data (e.g. splitting a pool of training data, e.g. original data 403 into subsets and rotating the training/validation among them). In another example, a pool of training data, e.g. as available on training data repository 401, is split using a defined ratio, e.g. 80:20 split such that 80% of the data is for training and forms the original data 403 while 20% of the data is used for testing of the model. In one example implementation, a merchant uploading digital images of a new product onto the e-commerce platform 100, may be presented with a list of attribute suggestions for tagging the input product image, such to increase search discoverability including via the application search, recommendation and support 128. However, if user input is received via the merchant device 102 or other computing devices to the engine 300 whereby a threshold number of those attribute tags are rejected across the platform or other indications of feedback data such as shown in steps 512 and 514 of FIG. 5A, this may trigger re-evaluation and retraining of the model, such as shown at step 504 of FIG. 5A.

The precision data 409 may include a required precision constraint or limitation on the precision of the classifier model for classifying each output attribute of the set of attributes being classified. In other words, it is a standard placed on the classifier model to ensure that it meets a certain level of precision when making predictions for each attribute output. The precision may be computed by the performance evaluation module 404 as a measure of the number of positive class predictions that actually belong to the positive class. On the other hand, the recall data 411 includes a recall constraint which is a specific requirement on the recall of the classification model's prediction for each attribute (e.g. multi-attribute classifier 413). Recall is the percentage of data samples that a machine learning model correctly identifies as belonging to a particular class of interest, out of total samples for that class. Put another way, it is the fraction of true positive predictions among all the actual positive instances in the dataset. Additionally, the training criteria 417 may include an F-measure which provides a threshold of a single F-score score to be met, this score balances both the precision and recall in one number. Other evaluation metrics and corresponding thresholds may be stored within the training criteria 417 for evaluating the classifier 412 performance.

Thus, the performance evaluation module 404, is configured to evaluate performance of the multi-attribute classifier 413, according to one or more performance metrics in the training criteria 417.

In one example implementation, upon receiving the training data (e.g. images with attribute data for different attribute types), the multi-attribute training module 402 trains the multi-attribute classifier 413 model and subsequently tests the performance of the model using the training criteria 417 via the performance evaluation module 404. Such coordination of modules performing various tasks and triggering of other modules to perform the tasks described herein may be managed via a model manager 408 for orchestrating the various processes between the modules and delegating. For example, a performance score may be calculated for each of the criteria types in the training criteria 417 and the performance score may be compared for each attribute being classified may be compared to thresholds or rules set in the training criteria 417 by the performance evaluation module 404 to determine whether the training criteria is satisfied or additional single attribute classifiers should be generated. Such iterative process of model evaluation and generation by the engine 300 is visualized in the schematic example flowchart of FIG. 5A illustrating model operations 502.

Referring to FIGS. 4 and 5A, if after the multi-attribute classifier 413 is trained at step 504, the classifier 413 is then tested via the testing data repository 407 to determine a comparison of the classification performance metrics for each attribute to the constraints in the training criteria 417 at step 506. If it is determined, at step 507, that the performance criteria is met (e.g. the training criteria 417), the classifier 412 containing the multi-attribute classifier 413 is deployed into production via the production module 410 at step 516. If the performance of multi-attribute classifier 413 does not meet the criteria, a single attribute training module 406 is triggered for training to generate a single attribute classifier 415 at step 508 for classification of the attribute which does not meet the performance criteria to cooperate with the multi-attribute classifier 413 in the prediction task. In this implementation, as illustrated in the example of FIG. 5A, the performance of the multi-attribute classifier 413 in combination with the single attribute classifier 415 providing the classifier 412 may be considered together and tested using testing data in the testing data repository 407. The performance of the combined classifier 412 having both the single and multi-attribute classifier against the training criteria 417 (e.g. precision and recall values) is then evaluated at step 510 and if the training criteria is met, then the production module 410 generates the joint classifier 412 at step 509. In some optional aspects, if the training criteria is not met at step 510, then at step 512, the engine 300 may request, from one or more associated computing devices (e.g. an associated computing device triggering the request for training of the classification models), additional training data and/or different training data which may be stored in new data 405 and trigger retraining of the models at step 514, back to step 504. Generally, the training data in the training data repository may be pre-labelled or tagged data samples with attribute labels, and in some examples, may be automatically generated training data.

In some optional aspects, the engine 300 may present on a user interface of one or more associated computing devices (not shown), the request for training data and retrain the classifier 412 based on such data.

In at least some examples, the training criteria 417 may contain the following performance rules for triggering generation of a respective single attribute classifier:
a. Attribute values which don't reach the precision constraint in the precision data 409 (for example <0.9) or
b. Attribute values which do reach the precision constraint but have low recall as compared to threshold in the recall data 411 (for example <0.8)

Another example schematic view of training the classifier 412 by the engine 300 is illustrated in the operation 520 in FIG. 5B. At step 504 shown is the example operation steps of training the multi-attribute classifier 413 which may include training at step 525 via the multi-attribute training module 402, threshold selection at step 527 (which may be manual, automatic or semi-automatic via machine learning applied to prior threshold selection data to determine optimal thresholds for each performance criteria). Subsequent to step 527, the multi-attribute training process may include performance evaluation which may be performed by the engine 300 at step 529, via the performance evaluation module 404. Subsequent to step 529, the engine 300 may listen to or otherwise receive threshold override requests at step 531 (which may be processed by the threshold override module 414 to determine whether to regenerate the classifier based on the new thresholds). Once the multi-attribute classifier 413 is generated at step 504, the training criteria is applied at step 506 to evaluate the performance of each attribute being classified. For underperforming attributes, the engine 300 is configured at step 508, to generate and train a single attribute classifier. Such generation may include training the model at step 533, such as via new data 405 specifically selected by the engine 300 to improve the performance of the underperforming attribute classification. At step 535, threshold selection occurs and the model is evaluated at step 537 via the performance evaluation module 404. If the performance metrics do not meet a defined criteria, the training may also include requesting and/or receiving threshold overrides for the model at step 539 which may be processed by the threshold override module 414 to regenerate and/or retrain the single attribute classifier and improve iteratively its performance. Conveniently, an advantage of the operation 520 is improving multi-attribute classification prediction precision and coverage.

### Operation of the Single Attribute Training Module 406

Thus, when the performance evaluation module 404 applies the testing data in the testing data repository 407 and determines that one or more trigger rules in the training criteria indicate underperforming attribute(s) (e.g. a performance score for precision or recall is below a desired value), the model manager 408 then triggers the single attribute training module 406 for training and generation of a single attribute classifier 415 for the underperforming attribute. The single attribute classifier 415, once generated, is combined with the multi attribute classifier 413 to generate an updated classifier 412 to predict all attribute values with high precision while maximizing the prediction coverage (recall).

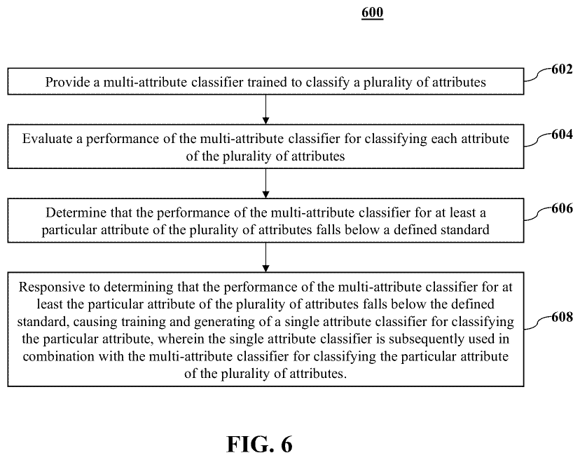

Referring now in more detail to the single attribute training module 406, with reference to FIG. 4 and the operations illustrated in FIGS. 5A-5C and 6, for training and generating the single attribute classifier 415 to classify the particular attribute which is underperforming in the multi-attribute classifier 413. Based on the particular attribute, the engine 300 may alter, via the single attribute training module 406, the criteria for including images in the new training set (e.g. new data 405) for training a new single attribute model. For example, if the problematic classification attribute is “heel height” as it relates to shoe image products, the model manager 408 may require the new data training set, e.g. new data 405, to contain a high proportion of images with “heel-type” tags. Thus, the model manager 408 may filter an original data 403 training set such as to bias the new data 405 set to have a higher percentage of data samples with the attribute of interest.

In yet another aspect, if the engine 300 detects such as via the performance evaluation module 404, that a root cause of the underperforming multi attribute classifier is related to data drift, then the single attribute training module 406 may be specifically directed by the model manager 408, to train the single attribute classifier 415 using data samples having the attribute of interest by accessing the most recent data samples as the new data 405. Thus, the model manager 408 may for example manage updating the training data (e.g. original data 403 set) to include only more recent data samples in the new data 405.

In yet another aspect, the model manager 408 may direct the single attribute training module 406 to train on a proportional set of input data having an equal number of samples for different attribute classes or values of the attribute type by generating the new data 405 having such equal proportion of samples as extracted from the original data 403. For example, the new data 405 may be extracted from the original data 403 having an equal proportion across the classes to detect for that attribute of interest, i.e. since the attribute of interest relates to “heel height”, the new data 405 is selected to contain an equal number of samples for different attribute values. In one example, the new data 405 may be specifically configured to contain an equal proportion of data samples for the different attribute values of the attribute of interest. In the given example, this may include equal samples of each of “high heels”, “platform heels”, “kitten heels”, “no heel”, etc. in the new data 405.

In yet another further aspect, the model manager 408 may configure the new training data set, e.g. new data 405, for training the single attribute classifier 415 to expand the training data set to include images from other object types/categories beyond the current object type or category of interest (e.g. beyond product types=‘shoes’). That is, upon detecting the trigger for generating the single attribute classifier 415, the training data, e.g. original data 403, used to train the multi attribute classifier 413 may be updated to the new data 405 and includes additional data samples (e.g. obtained from other data stores of the engine 300 and/or stored on the training data repository 401) having other types/categories of the underlying products. Thus, if the problematic attribute and attribute value for the multi-attribute classifier 413 is “color” and value “red” for use with a particular product type or category, e.g. shoes, then the model manager 408 constructs the new data 405 to broaden the “colour” training set samples to include other product types/categories, e.g. non-shoe related products having a similar attribute value (e.g. digital images with red shovels, red hats). Thus, in this case, the new data 405 constructed expands the training data to samples of other product types or categories having the attribute of interest and/or specific attribute value leading to decreased performance.

In at least some implementations, the classification model provided by the classifier 412, the multi-attribute classifier 413, and/or the single attribute classifier 415 may include at least one supervised machine learning model for classification including but not limited to: a linear classifier, support vector machine (SVM), neural network, decision trees, k-nearest neighbor, and random forest. Preferably, if the input data being classified are digital images, the classifier 412 is a convolutional neural network (CNN).

### Inference

Referring again to FIGS. 4 and 5A, once the single attribute classifier 415 is trained and generated, the production module 410 combines the newly trained single attribute classifier 415 model with the previous multi-attribute classifier 413 model in future classification tasks. Notably, the production module 410 also configures the multi-attribute classifier 413 to provide a null or empty output for the attribute or feature that does not meet the performance criteria (e.g. precision constraint or recall constraint stored in training criteria 417) once the newly trained single attribute classifier 415 model is generated. In this way, in production, if a null output for a particular classification attribute is detected from the multi-attribute classifier 413 then the engine 300 triggers the single attribute classifier 415 to perform the classification for the particular classification attribute which was associated with the null output. An example schematic flow of operations 524 for the inference stage of the classifier 412 is illustrated in FIG. 5C.

Notably as illustrated in FIG. 5C, in an inference phase of the classifier 412 of FIG. 4, shown at step 526, the multi-attribute classifier 413 model makes predictions based on live data (e.g. input actual digital images of e-commerce products) to produce a set of outputs, one for each attribute of the input data being considered. For attributes which do not yield any outputs, or a “null” output is generated for the attribute value, the engine 300 is configured, at step 528 to apply the single attribute classifier 415 and perform the prediction for the attribute. The predictions are combined at step 530, by the engine 300, from the multi-attribute classifier 413 and the single attribute classifier 415 to generate the predictions at step 530.

FIG. 6 illustrates an example flowchart of operations 600 which may be performed by the engine 300 for intelligently and dynamically updating an existing underperforming multi-attribute classifier (e.g. a multi-class multi-output classification model) for classifying a plurality of attributes by constructing a new multi-attribute model architecture which combines the existing multi-attribute classifier with a new single attribute classifier which is specifically trained to classify a particular attribute of the plurality of attributes underperforming in the existing multi-attribute classifier (e.g. having a classification performance below a desired standard or performance threshold).

The operations 600 are further described below with reference to FIGS. 1-4, 5A-5C and 6.

Put another way, the operations 600 of the engine 300 may generally be configured for automatically triggering the training of a new specialized classification model, (e.g. single attribute classifier generated by the single attribute training module 406) for a specific attribute responsive to the engine 300 detecting, via a performance evaluation module 404, that the performance of a current multi attribute classification model (e.g. as generated via the multi-attribute training module 402) with respect to the specific attribute has fallen below a desired constraint, e.g. a threshold. Additionally, in at least some aspects, operations of the engine 300 may be configured (e.g. via the production module 410) for coupling the newly trained single attribute classification model to the currently existing multi-attribute classification model for future classification tasks.

The computing device for carrying out the operations 600 may comprise at least one processor configured to communicate with a display to provide a graphical user interface (GUI) where the computing device has a network interface to receive various features of product information (e.g. text, images, combinations thereof, and other product information as may be stored in training data repository 401, training criteria 417, testing data repository 407) and wherein instructions (stored in a non-transient storage device), when executed by the processor, configure the computing device to perform operations such as operations 600.

In at least some implementations, the GUI of the computing may be configured to receive user input for modifying various values in the data repositories of the engine 300 such as for example, receiving user input relating to training criteria 417 including thresholds, precision data 409 and recall data 411 as well as other performance constraints used to evaluate each of the multi-attribute and single attribute models generated by the engine 300.

As will be described, operations 600 of the engine 300 utilize an improved system architecture of computing components as shown in the example of FIG. 4, which allow leveraging the benefits of a multi-attribute classifier, which may be underperforming in terms of classifying certain attributes of an input dataset (e.g. an image dataset, a text dataset or a combination thereof) and couples it to a specifically trained and generated single attribute classifier which is targeted to classifying the underperforming attribute, thereby improving the performance of the overall classification while applying benefits of each of the multi and single attribute classifiers.

In at least some aspects of the operation 600, the supervised learning models being generated by the engine 300 via the multi-attribute training module 402 and/or the single attribute training module 406 includes a neural network, such as a convolutional neural network, for classifying the e-commerce input data containing at least image content (and in some aspects, text portions) into a set of attributes or categories of products, each of the output attributes having attribute values which may be binary or multi-output. As described earlier, the classifier 412 is a multi-class multi-output classifier such that upon receiving an input image, each attribute is associated with its own output and attribute output may be tested individual to determine whether a defined performance criteria is met such as via the performance evaluation module 404 described with reference to FIG. 4.

In operation 602, the processor receives a multi-attribute classifier to classify a plurality of attributes, such as for an input image of an e-commerce product. An example multi-attribute classifier 413 and the generation of same via the multi-attribute training module 402 and the testing thereof via the performance evaluation module 404 was described with reference to FIG. 4.

Notably, following operation 602, in operation 604, the processor may be configured via the performance evaluation module 404 to evaluate a performance of the multi-attribute classifier 413 for classifying each attribute of the plurality of attributes. This may include generating a performance score for each performance criteria (e.g. precision, recall, combinations thereof, etc.) of each output attribute by testing the classifier 413 against a testing data set as may be provided in the testing data repository 407. An example process for model evaluation was also illustrated in FIG. 5A at steps 504 and 506.

Following operation 604, at operation 606, the processor is configured, via the performance evaluation module 404, to determine whether the performance of the multi-attribute classifier 413 for classifying a particular attribute (e.g. attribute type “color” for product images of “shoes”) falls below a defined standard. As noted earlier, the defined standard may relate to one or more performance metric rules and thresholds stored within the training criteria 417 which may include precision and recall constraints stored within precision data 409 and recall data 411 respectively. An example implementation of comparing the performance score (e.g. precision criteria or recall) for classifying each attribute of the multi-attribute classifier to a defined threshold is shown at step 506 in FIG. 5B.

Following operation 606, at operation 608 responsive to determining that the performance of the multi-attribute classifier 413 for at least the particular attribute (e.g. “color”) of the plurality of attributes (e.g. “color”, “size” and “product type”) falls below the defined standard, the processor of the engine 300 causes training and generating of a single attribute classifier 415 for classifying the particular attribute via the single attribute training module 406. Notably, the single attribute classifier 415 is subsequently used in combination with the multi-attribute classifier 413 (e.g. to form the classifier 412) for classifying the particular attribute of the plurality of attributes. Put another way, responsive to the performance associated with classification of a particular attribute falling below a threshold for the multi-attribute classifier 413, the engine 300 triggers a training task for training a new single attribute classifier 415 model to classify that particular attribute. Based on the attribute, the processor may alter the criteria for including images in the new training set, e.g. new data 405 for training a new single attribute model as per the examples described earlier. For example, the processor may modify the training data from the initial training data used for the multi-attribute classifier 413 to emphasize data samples having the particular attribute, e.g. such that the new data 405 contains a high proportion of images with the problematic attribute (e.g. “color”).

Conveniently, in this manner, the generated combined classification model (e.g. classifier 412) is only slightly larger in terms of storage size than the multi-attribute classifier 413 and takes slightly more time for prediction while generating improved results. As a result having a combined model has better quality of results, less resource consumption, and maximizes the prediction coverage.

In one or more examples, the functions described may be implemented in hardware, software, firmware, or combinations thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including such media that may facilitate transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be available media that can be accessed by one or more computers or one or more processors to retrieve instructions, code and/or data structures for implementation of the techniques described in this disclosure. A computer program product may include a computer-readable medium. By way of example, and not limitation, such computer-readable storage media can comprise RAM, ROM, EEPROM, optical disk storage, magnetic disk storage, or other magnetic storage devices, flash memory, or any other medium that can be used to store desired program code in the form of instructions or data structures and that can be accessed by a computer. In addition, any connection is properly termed a computer-readable medium. For example, if instructions are transmitted from a website, server, or other remote source using wired or wireless technologies, such are included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more general-purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. In addition, the techniques could be fully implemented in one or more circuits or logic elements. The techniques of this disclosure may be implemented in a wide variety of devices or apparatuses, an integrated circuit (IC) or a set of ICs (e.g., a chip set).

Furthermore, the elements depicted in the flowchart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it may be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

Various embodiments have been described. These and other embodiments are within the scope of the following claims.

1. A computer implemented method comprising:
providing a multi-attribute classifier trained to classify a plurality of attributes;
evaluating a performance of the multi-attribute classifier for classifying each attribute of the plurality of attributes;
determining that the performance of the multi-attribute classifier for at least a particular attribute of the plurality of attributes falls below a defined standard; and
responsive to determining that the performance of the multi-attribute classifier for at least the particular attribute of the plurality of attributes falls below the defined standard, causing training and generating of a single attribute classifier for classifying the particular attribute, wherein the single attribute classifier is subsequently used in combination with the multi-attribute classifier for classifying the particular attribute of the plurality of attributes.

2. The method of claim 1 wherein the defined standard is a threshold associated with training criteria for the multi-attribute classifier and evaluating the performance includes:
applying the multi-attribute classifier to a test data set to determine a performance score for each said attribute; and
comparing the performance score for at least the particular attribute to the threshold for the multi-attribute classifier in classifying attributes.

3. The method of claim 1, wherein the single attribute classifier is caused to be trained with a new data set different from an original training data set for the multi-attribute classifier.

4. The method of claim 3, wherein the new data set is biased towards containing only samples related to the particular attribute.

5. The method of claim 3, wherein the new data set is a subset of a larger data set, and the original training data set was generated by filtering that larger data set based on a criterion.

6. The method of claim 4 wherein, the new data set was generated by filtering the original training data set for samples having only the particular attribute.

7. The method of claim 3, further comprising:
determining that the particular attribute is related to a particular category of object and causing the new data set to contain samples related to the particular attribute for categories of available objects other than the particular category of object in addition to samples related to the particular category of object.

8. The method of claim 1 wherein the defined standard is a precision constraint value.

9. The method of claim 1 wherein the defined standard includes a precision constraint value and a recall value; and wherein determining that the performance for the particular attribute falls below the defined standard includes:
determining that the performance for the particular attribute meets the precision constraint value; and
responsive to determining that the performance for the particular attribute meets the precision constraint value.

10. The method of claim 1, the method further comprising:
providing a system comprising the multi-attribute classifier and the single attribute classifier; and
in response to the particular attribute having the performance below the defined standard for the multi-attribute classifier, the system configured for applying the single attribute classifier instead of the multi-attribute classifier for classifying the particular attribute.

11. The method of claim 2, wherein training of the single attribute classifier additionally comprises evaluating performance for the single attribute classifier to determine whether meets the defined standard and responsive to evaluating that the performance fails to meet the defined standard causing re-training of the single attribute classifier.

12. The method of claim 1, further comprising:
tracking performance of the multi-attribute classifier together with one or more single attribute classifiers to determine whether to generate additional single attribute classifiers based on the tracking, wherein each single attribute classifier is used for classifying a respective associated attribute instead of the multi-attribute classifier.

13. The method of claim 1, wherein the multi-attribute classifier is a multi-class multi-output classifier wherein each said attribute of the plurality of attributes input to the multi-attribute classifier is associated with a separate classification output.

14. A computer system comprising:
at least one processor; and
a storage storing instructions that, when executed by at least one of the at least one processor, cause the system to:
provide a multi-attribute classifier trained to classify a plurality of attributes;
evaluate a performance of the multi-attribute classifier for classifying each attribute of the plurality of attributes;
determine that the performance of the multi-attribute classifier for at least a particular attribute of the plurality of attributes falls below a defined standard; and
responsive to determining that the performance of the multi-attribute classifier for at least the particular attribute of the plurality of attributes falls below the defined standard, cause training and generating of a single attribute classifier for classifying the particular attribute, wherein the single attribute classifier is subsequently used in combination with the multi-attribute classifier for classifying the particular attribute of the plurality of attributes.

15. The system of claim 14 wherein the defined standard is a threshold associated with training criteria for the multi-attribute classifier and evaluating the performance includes:
applying the multi-attribute classifier to a test data set to determine a performance score for each said attribute; and
comparing the performance score for at least the particular attribute to the threshold for the multi-attribute classifier in classifying attributes.

16. The system of claim 14, wherein the single attribute classifier is caused to be trained with a new data set different from an original training data set for the multi-attribute classifier.

17. The system of claim 16, wherein the new data set is biased towards containing only samples related to the particular attribute.

18. The system of claim 16, wherein the new data set is a subset of a larger data set, and the original training data set was generated by filtering that larger data set based on a criterion.

19. The system of claim 18 wherein, the new data set was generated by filtering the original training data set for samples having only the particular attribute.

20. The system of claim 16, wherein the instructions, when executed by the processor, further cause the system to: determine that the particular attribute is related to a particular category of object and cause the new data set to contain samples related to the particular attribute for categories of available objects other than the particular category of object in addition to samples related to the particular category of object.

21. The system of claim 14 wherein the defined standard is a precision constraint value.

22. A computer readable medium having instructions tangibly stored thereon, wherein the instructions, when executed by at least one processor of a computer system cause the computer system to:
provide a multi-attribute classifier trained to classify a plurality of attributes;
evaluate a performance of the multi-attribute classifier for classifying each attribute of the plurality of attributes;
determine that the performance of the multi-attribute classifier for at least a particular attribute of the plurality of attributes falls below a defined standard; and
responsive to determining that the performance of the multi-attribute classifier for at least the particular attribute of the plurality of attributes falls below the defined standard, cause training and generating of a single attribute classifier for classifying the particular attribute, wherein the single attribute classifier is subsequently used in combination with the multi-attribute classifier for classifying the particular attribute of the plurality of attributes.
